(19) United States
(12) Patent Application Publication
(10) Pub. No.: US 2025/0238449 A1
(43) Pub. Date: Jul. 24, 2025

(54) GENERATING QUERY OUTCOMES USING DOMAIN-BASED CAUSAL GRAPHS AND LARGE GENERATIVE MODELS

(71) Applicant: Microsoft Technology Licensing, LLC, Redmond, WA (US)

(72) Inventors: Swati SHARMA, Hayward, CA (US); Maria Angels DE LUIS BALAGUER, Redmond, WA (US); Emre Mehmet KICIMAN, Seattle, WA (US); Ranveer CHANDRA, Kirkland, WA (US)

(21) Appl. No.: 18/421,812

(22) Filed: Jan. 24, 2024

(51) Int. Cl. G06F 16/33; G06F 16/34

(52) U.S. Cl. CPC G06F 16/3344; G06F 16/34

(57) ABSTRACT

This disclosure describes utilizing a causal query system to determine causal outcomes for domain-specific causal queries using a framework that includes causal graphs for targeted domains, a large generative model (LGM), and other models or systems. In various implementations, the causal query system provides a framework that includes generating domain-specific causal graphs, encoding or mapping the causal graphs with local data values, and using the encoded causal graphs to determine causal outcomes to causal queries. In some implementations, the causal query system uses the LGM and data resources (e.g., external sources) to populate missing values of an embedded causal graph before using the causal graph to determine causal outcomes.

### BACKGROUND

The landscape of computational devices has witnessed significant advancements in both hardware and software domains, particularly in the implementation of generative artificial intelligence (AI) models for task execution. For instance, current generative AI models enable the synthesis of information across various fields. The improved proficiency of these models has led to their widespread integration across numerous systems and applications. Indeed, various systems are incorporating generative AI models to solve problems that were previously deemed unfeasible. However, conventional systems encounter several technological challenges when attempting to effectively and accurately utilize generative AI models to produce desired results. Furthermore, in fields that require crucial interdisciplinary knowledge, generative AI alone yields inaccurate results.

### BRIEF DESCRIPTION OF THE DRAWINGS

The following detailed description provides specific and detailed implementations accompanied by drawings. Additionally, each of the figures listed below corresponds to one or more implementations discussed in this disclosure.

FIG. 1 illustrates an example overview of the causal query system using a framework that includes a causal graph and a large generative model to generate a response to a causal query.

FIG. 2 illustrates an example computing environment where the causal query system is implemented.

FIGS. 3A-3B illustrate example diagrams for generating a causal graph using a large generative model based on knowledgebase documents.

FIGS. 4A-4B illustrate example diagrams for generating a mapped and modified causal graph using the large generative model for a causal query.

FIGS. 5A-5B illustrate example diagrams for generating a response to the causal query based on the modified causal graph and using the large generative model.

FIG. 6 illustrates an example graphical user interface for providing a response to a causal query.

FIG. 7 illustrates an example series of acts in a computer-implemented method for generating a causal query output using a domain-based causal graph and one or more large generative models.

FIG. 8 illustrates example components included within a computer system used to implement the causal query system.

### DETAILED DESCRIPTION

This disclosure describes a causal query system that determines causal outcomes for domain-specific causal queries using a framework that includes causal graphs for targeted domains, a large generative model (LGM), and other models or systems. In various implementations, the causal query system provides a framework for generating domain-specific causal graphs, encoding or mapping the causal graphs with local data values, and using the encoded causal graphs to determine causal outcomes for causal queries. In some implementations, the causal query system utilizes the LGM and data resources (e.g., external sources) to populate missing values of an embedded causal graph before using the causal graph to determine causal outcomes. Notably, while this disclosure describes causal queries, the causal query system may apply similar approaches and techniques to non-causal queries, which still use causal graphs to solve the queries.

Implementations of the present disclosure provide benefits and solve problems in the art with systems, computer-readable media, and computer-implemented methods by using a causal query system to accurately and efficiently determine causal outcomes. As described below, the causal query system utilizes a large generative model (LGM) to efficiently determine causal outcomes to causal queries by using the LGM to determine which additional resources are needed and how to optimally leverage the additional resources. Additionally, the causal query system improves outcome accuracy by filling in missing values of an encoded causal graph, which is then used to determine unbiased causal outcomes.

To elaborate, in various implementations, the causal query system receives a causal query that corresponds to the target domain, along with a dataset for that target domain. In response, the causal query system maps or encodes data values from the dataset to nodes in a target domain causal graph. In some implementations, the causal query system also determines if one or more nodes in the mapped causal graph are missing data values. In these implementations, the causal query system populates the missing values with data obtained from a data resource, such as a data store or simulation model.

Additionally, the causal query system provides a causal script prompt, the causal query, and the modified causal graph to the LGM, which generates a causal query script. The causal query system also provides the causal query script and the modified causal graph to a causal analysis model, which generates a raw answer to the causal query. Furthermore, the causal query system uses the LGM to generate a plain language response from the raw answer and provides the plain language response in response to receiving the causal query. In some instances, the causal query system receives a non-causal query and generates a normal query script based on the normal query being submitted.

In various implementations, the causal query system generates a target domain causal graph using the LGM. For example, the causal query system uses the LGM to determine relationships between categories in the target domain based on knowledgebase documents. As mentioned above, the causal query system can encode the causal graph with user-specific data values, which the causal query system uses within the framework to determine user-specific targeted causal outcomes.

As described in this disclosure, the causal query system delivers several significant technical benefits in terms of improved efficiency and accuracy compared to existing systems. Moreover, the causal query system provides several practical applications that address problems related to providing accurate and unbiased causal outcomes that are also customized for targeted domains.

To illustrate, the framework provided by the causal query system improves efficiency compared to conventional systems. By using the LGM at various stages of the framework to interact with different components, the causal query system improves efficiency. To elaborate, the causal query system uses the LGM to determine which components to interact with and how to effectively communicate with a given component to achieve the desired outcome. For example, the causal query system uses the LGM to identify the appropriate data resource to call to access to obtain missing data values for a mapped causal graph. As another example, the causal query system uses the LGM to generate a script that instructs a causal analysis model to determine a requested causal outcome from a mapped causal graph. By using the framework and leveraging the LGM to efficiently target components, the causal query system achieves causal outcomes in fewer operations than conventional systems require.

As mentioned, the causal query system determines accurate and unbiased causal outcomes. For example, by correlating user-provided data with domain-specific causal graphs generated by the causal query system, the causal query system can determine causal outcomes to causal queries. Furthermore, the causal query system improves the accuracy and unbiasedness of causal outcomes by determining values for missing data in a mapped causal graph. Moreover, the causal query system provides accurate causal outcomes even in domains where data is otherwise too sparse to determine reasonable causal outcomes. In this way, the causal query system uses completed causal graphs to determine one or more causal outcomes as requested by a user.

These improvements in efficiency and accuracy are further manifested in data domains that include, complex, diverse, and precise data. To illustrate, the agriculture domain requires knowledge about crops, soils, weather patterns, ecological interactions, and water management. Furthermore, data from one agricultural operation can vary significantly from operations across a region, at an adjacent operation, or even within the same operation, making it challenging to determine accurate causal outcomes. Nonetheless, the framework provided by the causal query system allows for accurate and efficient determinations of causal outcomes for operations in the agriculture domain.

As illustrated in the foregoing discussion, this disclosure utilizes a variety of terms to describe the features and advantages of one or more implementations described. To illustrate, this disclosure describes the causal query system in the context of a cloud computing system.

As an example, the term “domain” refers to distinct areas or fields of knowledge, study, technology, or practices that are defined by recognizable boundaries. In this context, a “targeted domain” specifically refers to a particular field of knowledge or practice. Domains can be further divided into sub-domains, each of which can also be considered a domain in its own right. For instance, “medicine” could be considered a domain, with “internal medicine” being a sub-domain within the broader field of medicine. Each domain (including sub-domains) represents a specific area of expertise or application, providing a framework for understanding and categorizing information, practices, or technologies within that field.

It can also refer to the range of applicability of a patented invention. For example, in a patent for a new data encryption method, the domain could be defined as “data security in digital communications”. This term helps to categorize and understand the relevance and applicability of the patented invention. In some instances, the term “domain” can also refer to a specific market or industry where the patented invention is used or has potential use. For instance, a patent for a new type of solar panel could have a domain in the renewable energy industry.

The term “causal query” refers to a question or inquiry made within the context of a targeted domain or a causal graph associated with a targeted domain, where the question is aimed at understanding the cause-and-effect relationships between variables. A causal query typically involves identifying the impact of a change in one variable (the cause) on another variable (the effect). For instance, in a causal graph representing the factors affecting a machine's performance, a causal query might be: “What is the impact on the machine's performance if the input size is doubled?” In some instances, a causal query can be used to predict the outcome of a certain event based on the known relationships between variables in the causal graph. As noted above, while this disclosure describes causal queries, the causal query system may apply similar approaches and techniques to non-causal queries, which still use causal graphs to solve the queries.

While this document covers causal queries, in some implementations, the causal query system processes non-causal queries (e.g., normal queries) that question or inquire within the context of a target domain. In these implementations, the causal query system still uses a causal graph and the processes described below to respond to the query. For example, the causal query system receives a query of “How much carbon is in the soil?” and the causal query system uses the causal query to estimate the answer using one or more prediction approaches.

The term “causal graph” refers to a data structure used to represent cause-and-effect relationships between nodes (e.g., categories). In many instances, a causal graph indicates the impact of different factors on each other. In various implementations, a causal graph is a graphical model where nodes represent variables and edges represent causal relationships between the variables. In some instances, the edges are binary (yes if a causal relationship is present and no edge otherwise). In some instances, the edges indicate a correlation amount between two nodes, including a positive or negative correlation amount. In one or more implementations, a causal graph is a directed acyclic graph (DAG), where edges are directed from one vertex (e.g., node) in a manner that does not loop back to form a closed or repeated path. A “target domain causal graph” refers to a causal graph associated with a specific domain.

The term “mapped causal graph” refers to a client device encoded with data values from a dataset associated with a target domain. For example, a dataset (i.e., data values stored in a structured format) includes columns of categories (or topics or entities) and rows of measured data values in each category. When the dataset is merged, encoded, supplemented, mapped, or otherwise combined with a causal graph for the same domain, the values from the dataset are mapped to nodes having the same or corresponding categories.

As an example, a “large generative model” (LGM) is a large artificial intelligence system that uses deep learning and a large number of parameters (e.g., in the billions or trillions), which are trained on one or more vast datasets, to produce fluent, coherent, and topic-specific outputs (e.g., text and/or images). In many instances, a generative model refers to an advanced computational system that uses natural language processing, machine learning, and/or image processing to generate coherent and contextually relevant human-like responses.

Additionally, large generative models have applications in natural language understanding, content generation, text summarization, dialogue systems, language translation, creative writing assistance, image generation, audio generation, and more. A single large generative model often performs a wide range of tasks based on receiving different inputs, such as prompts (e.g., input instructions, rules, example inputs, example outputs, and/or tasks), data, and/or access to data. In response, the large generative model generates various output formats ranging from one-word answers to long narratives, images and videos, labeled datasets, documents, tables, and presentations.

Moreover, large generative models are primarily based on transformer architectures to understand, generate, and manipulate human language. LGMs can also use a recurrent neural network (RNN) architecture, a long short-term memory (LSTM) model architecture, a convolutional neural network (CNN) architecture, or another architecture type. Examples of LGMs include generative pre-trained transformer (GPT) models including GPT-3.5 and GPT-4, bidirectional encoder representations from transformers (BERT) model, text-to-text transfer transformer models such as T5, conditional transformer language (CTRL) models, and Turing-NLG. Other types of large generative models include sequence-to-sequence models (Seq2Seq), vanilla RNNs, and LSTM networks. In various implementations, an LGM is a multi-modal generative model that receives multiple input formats (e.g., text, images, video, data structures) and/or generates multiple output formats.

The term “prompt” refers to an input or question provided by the user to the large generative model (LGM). A prompt serves as the primary source of information for the LGM to understand a request or query. For example, a prompt can be a specific question, a request for information, or a command for action. The LGM processes these prompts and generates responses based on the information provided in the prompt, the context of the conversation, and the guidelines or parameters set by any accompanying system-level prompts. For instance, a user prompt could be a request for a definition, or a query about a specific domain. A prompt may be generated based on a user prompt. Examples of prompts include a causal graph creation prompt, a causal query prompt, a causal script prompt, and a plain language prompt, which are each further described below.

The terms “system-level prompt” or “system prompt” refer to contextual information or directives provided to the LGM by the causal query system. In some instances, a system-level prompt is a meta prompt that provides important contextual information, such as meta-information about a domain, to the LGM. In some implementations, a system prompt includes general framing information to ensure that the large generative model understands the correct context, syntax, and grounding information of the data it is processing. Additionally, in various implementations, a system prompt can include specific guidelines, limitations, examples, or parameters within which the LGM should operate. For example, the system-level prompt includes a set of guardrails and/or guidelines for ensuring responsible generative outputs.

In this disclosure, the term “LGM output” refers to the generated content or responses produced by a large generative language model based on the given input. The LGM output encompasses any form of textual, numerical, or multimedia information generated by the LGM. In some instances, LGM output includes a set of variant prompt injection attacks. In some implementations, LGM outputs include processed data from a targeted LGM. In these implementations, the LGM output is referred to as “targeted LGM output.”

The term “causal analysis model” refers to a computational model designed to analyze scripts or code to answer causal queries or make causal predictions. This model operates within the framework of causal graphs and causal queries, using statistical and machine-learning techniques to establish and quantify cause-and-effect relationships between variables. It processes input data, which can include code and a causal graph (e.g., a mapped or modified causal graph encoded with data values) and applies causal analysis to identify the impact of different factors on each other. The causal analysis model can generate predictions about the outcomes of certain events based on the known relationships between variables in the causal graph. In various implementations, a causal analysis model returns a simple or raw answer as output. In some implementations, a causal analysis model is implemented in Python or another programming language. In some implementations, a causal analysis model is a predictive or other type of machine-learning model.

Additionally, as an example, a “network” refers to one or more data links that enable electronic data transport between computer systems and/or modules and/or other electronic devices. A network may include public networks such as the Internet as well as private networks. When information is transferred or provided over a network or another communications connection (either hardwired, wireless, or a combination of hardwired or wireless) to a computer, the computer properly views the connection as a transmission medium. Transmission media can include a network and/or data links that can be used to carry the needed program code means in the form of computer-executable instructions or data structures and which can be accessed by a general-purpose or special-purpose computer. Combinations of the above are also included within the scope of computer-readable media.

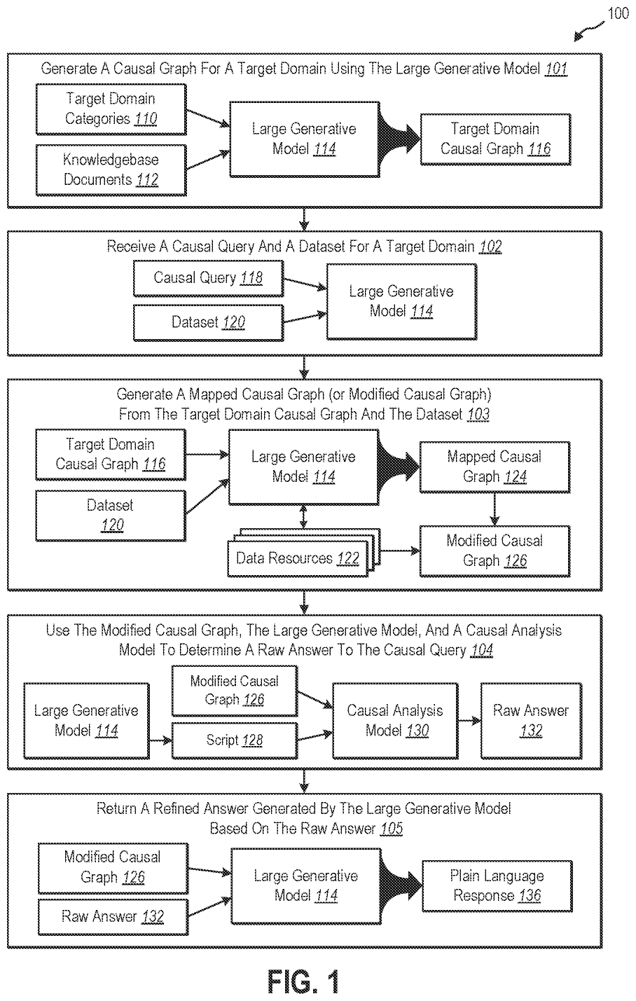

Implementation examples and details of the causal query system are discussed in connection with the accompanying figures, which are described next. For example, FIG. 1 illustrates an example overview of the causal query system using a framework including a causal graph and a large generative model to generate a response to a causal query according to some implementations. As shown, FIG. 1 includes a series of acts 100 performed by or with the causal query system.

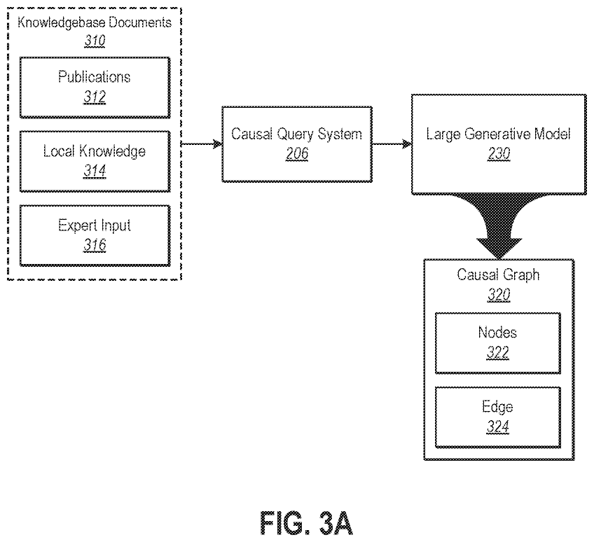

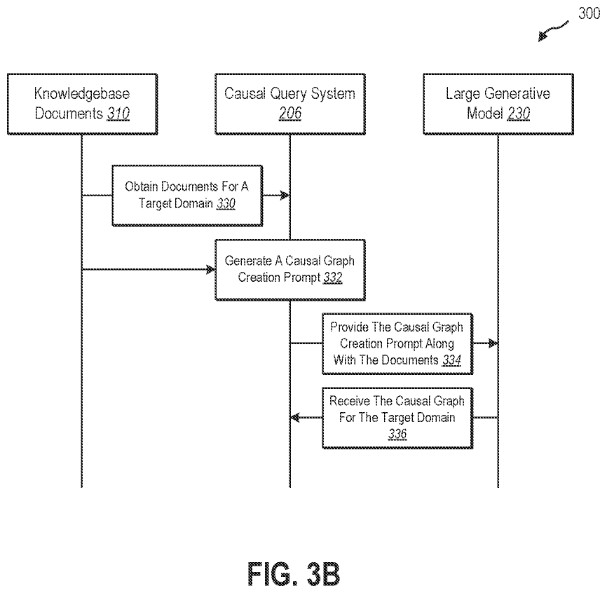

As shown in FIG. 1, the series of acts 100 includes act 101 of generating a causal graph for a target domain using the large generative model. For instance, the causal query system generates and provides a causal graph creation prompt along with target domain categories 110 and knowledgebase documents 112 to a large generative model 114, where the causal graph creation prompt instructs the large generative model 114 to generate a target domain causal graph 116 that shows relationships between the target domain categories 110. Additional details about generating a causal graph for a target domain are provided below in connection with FIGS. 3A-3B.

Act 102 includes receiving a causal query and a dataset for a target domain. For example, the causal query system receives a user request that includes a causal query 118 for a specific context (e.g., a target domain) from a client device associated with a user. In many instances, the dataset 120 is provided in connection with the causal query 118 or a previous causal query. In addition, the causal query system receives a dataset 120 that corresponds to the target domain. For instance, the causal query 118 and the dataset 120 both correspond to agricultural farming operations. As mentioned above, in various implementations, the user request includes a normal non-causal query for the target domain.

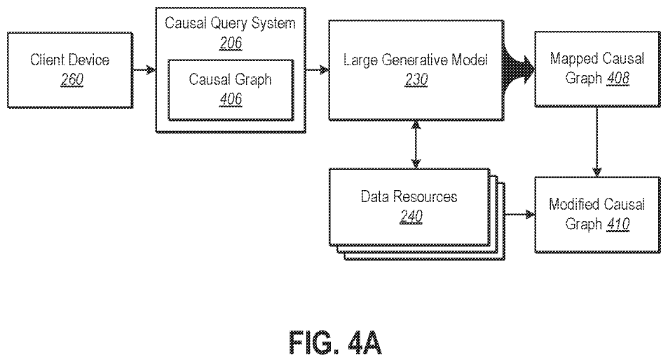

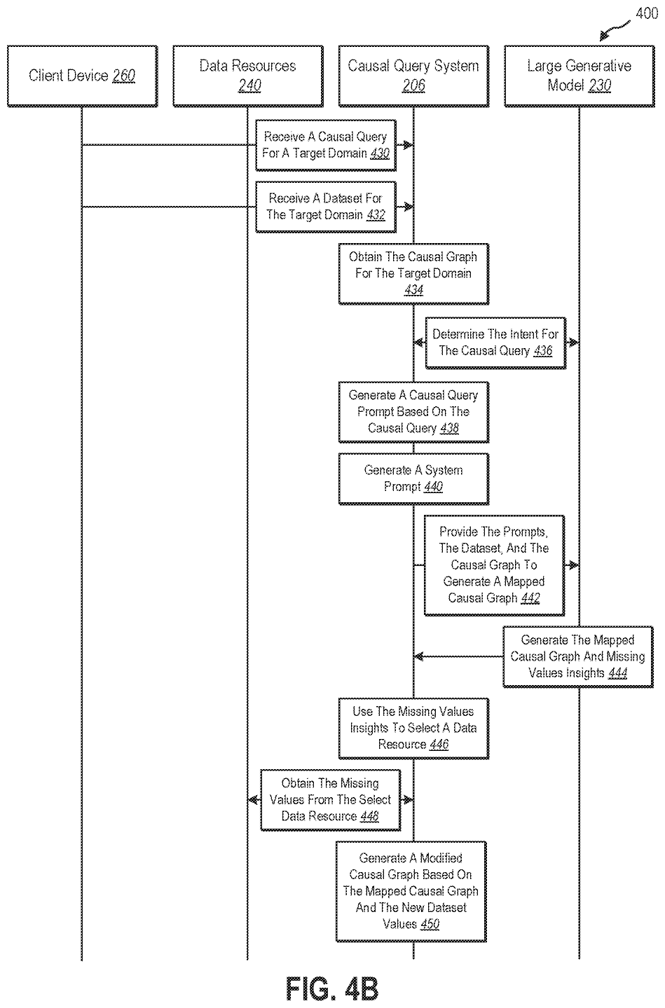

The causal query system may use the large generative model 114 to generate a causal response to the query. More specifically, the causal query system uses a framework that leverages the large generative model 114 by making multiple requests (either in separate prompts or a combined prompt) that aid the causal query system in determining the necessary data, components, and operations needed to generate an accurate and unbiased response to a causal query. Additional details about receiving a causal query associated with a target domain are provided below in connection with FIGS. 4A-4B.

Act 103 includes generating a mapped causal graph (or modified causal graph) from the target domain causal graph and the dataset. In various implementations, the causal query system generates and provides a causal query prompt, and a system prompt in some cases, to instruct the large generative model 114 to generate a mapped causal graph 124 by encoding the dataset 120 with the target domain causal graph 116.

In some implementations, the causal query system also instructs the large generative model 114 to determine missing values in the mapped causal graph 124, determine one or more of the data resources 122 that can be used to determine the missing values, determine how to communicate with a selected data resource to obtain the missing values, and add them to the mapped causal graph 124 (to generate a modified causal graph 126). Additional details about generating a mapped causal graph 124 and a modified causal graph 126 are provided below in connection with FIGS. 4A-4B.

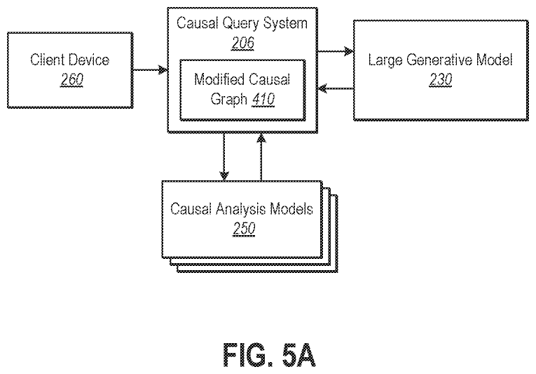

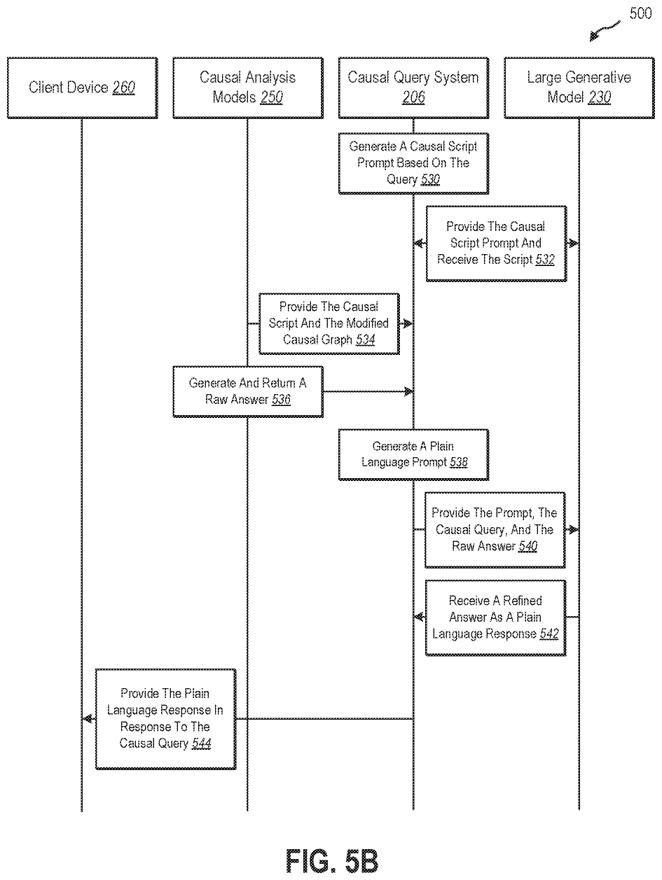

Act 104 includes using the modified causal graph, the large generative model, and a causal analysis model to determine a raw answer r to the causal query. For example, the causal query system generates and provides a causal script prompt to the large generative model 114 instructing it to generate code or a script 128 to provide to a causal analysis model 130. For example, the causal query system provides the mapped causal graph 124 or the modified causal graph 126 along with the script 128 to the causal analysis model 130, where the causal analysis model 130 determines a raw answer 132 to the causal query 118 based on the causal graph for the target domain. Additional details about generating a raw answer using the large generative model 114 and a causal analysis model 130 are provided below in connection with FIGS. 5A-5B.

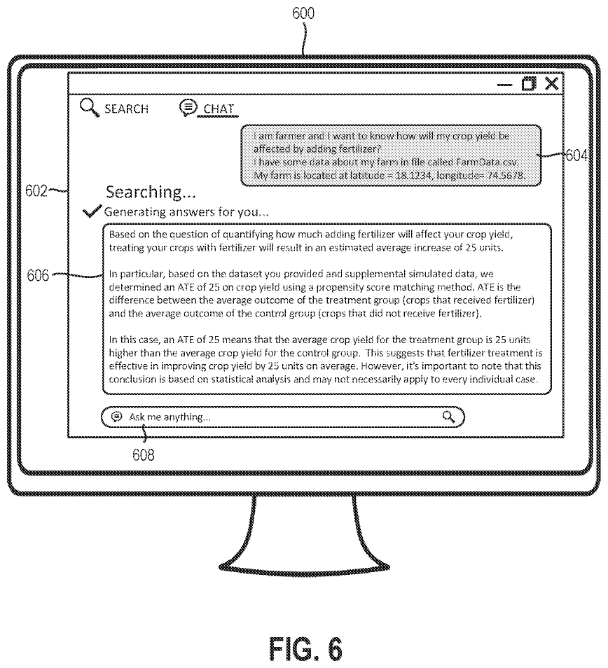

Additionally, act 105 includes returning a refined answer generated by the large generative model based on the raw answer. For example, the causal query system generates and provides a plain language prompt to the large generative model 114 with instructions to change the raw answer 132 into a refined answer in the form of a plain language response 136 for the modified causal graph 126. The causal query system then returns the plain language response 136 to the client device that provided the causal query 118. Additional details about generating a refined answer using the large generative model 114 and returning a plain language response are provided below in connection with FIGS. 5A-5B as well as illustrated in FIG. 6.

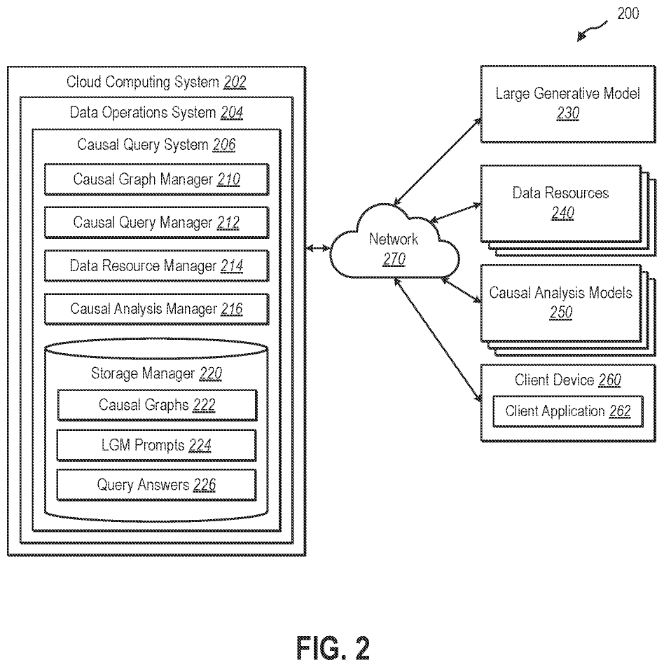

With a general overview in place, additional details are provided regarding the components, features, and elements of the causal query system. To illustrate, FIG. 2 shows an example computing environment where the causal query system is implemented according to some implementations. In particular, FIG. 2 illustrates an example of a computing environment 200 with various computing devices associated with a causal query system 206. While FIG. 2 shows example arrangements and configurations of the computing environment 200, the causal query system 206, and associated components, other arrangements and configurations are possible.

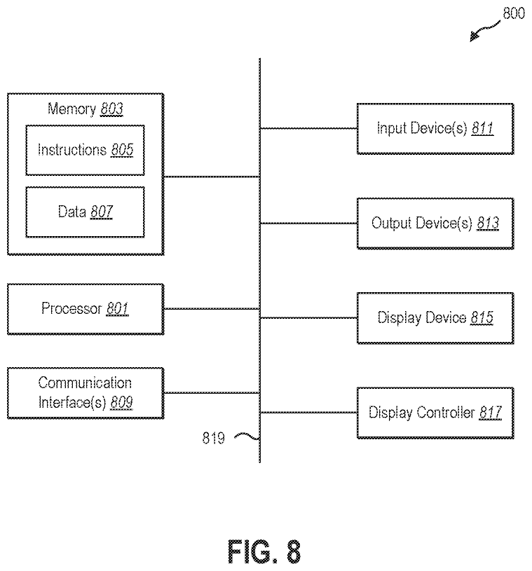

As shown, the computing environment 200 includes a cloud computing system 202 associated with the causal query system 206, a large generative model 230, data resources 240, causal analysis models 250, and a client device 260, each connected via a network 270. Each of these components may be implemented on one or more computing devices, such as a set of one or more server devices. Further details regarding computing devices are provided below in connection with FIG. 8, along with additional details regarding networks, such as the network 270 shown.

As shown, the cloud computing system 202 includes a data operations system 204, which implements the causal query system 206. In various implementations, the data operations system 204 facilitates operations and functions for data across various domains. For example, the data operations system 204 facilitates data measurements, automation, and data storage. In various implementations, the data operations system 204 provides a user interface to interact with the causal query system 206 and request causal queries.

In FIG. 2, the data operations system 204 includes the causal query system 206. In some implementations, the causal query system 206 is located on a separate computing device from the data operations system 204 within the cloud computing system 202 (or apart from the cloud computing system 202). In various implementations, the data operations system 204 operates without the causal query system 206.

As mentioned earlier, the causal query system 206 generates causal query outcomes for causal queries using domain-based causal graphs and large generative models. As shown, the causal query system 206 includes various components and elements that are implemented in hardware and/or software. For example, the causal query system 206 includes a causal graph manager 210, a causal query manager 212, a data resource manager 214, a causal analysis manager 216, and a storage manager 220. The storage manager 220 includes causal graphs 222, LGM prompts 224, and query answers 226.

As mentioned above, the causal query system 206 includes the causal graph manager 210, which manages generating, building, and modifying causal graphs 222 for various domains. In various implementations, the causal graph manager 210 communicates with the large generative model 230 (e.g., using one or more LGM prompts 224 such as a causal graph creation prompt) to generate causal graphs 222, as described.

The causal query system 206 includes the causal query manager 212, which receives and responds to causal queries, such as those from the client device 260. For example, when receiving a causal query, the causal query manager 212 activates the framework needed to determine an accurate and unbiased answer to the query. In some instances, the causal query manager 212 provides one or more of the LGM prompts 224 (e.g., a causal query prompt and system prompt) to the large generative model 230 as part of the framework.

In some implementations, the causal query manager 212 accesses one or more of the causal graphs 222 from a target domain that corresponds to the target domain of a received causal query. In various implementations, the causal query manager 212 uses the large generative model 230 to generate a mapped causal graph that combines data values with corresponding nodes (e.g., categories) in a causal graph for the same target domain.

The causal query system 206 includes the data resource manager 214, which manages calling and retrieving data from the data resources 240. For example, the data resource manager 214 uses the large generative model 230 to determine missing values from a mapped causal graph, which data resource to call to obtain the missing values, and how to call the selected data resource. The data resource manager 214 may generate a modified causal graph by supplementing and/or populating the mapped causal graph with the data values obtained from the data resources 240.

The causal query system 206 includes the causal analysis manager 216, which works with the causal analysis models 250 to determine query answers 226. In some implementations, the causal analysis manager 216 communicates with the large generative model 230 (e.g., using one or more LGM prompts 224 such as a causal script prompt) to generate code or a script to provide to one or more of the causal analysis models 250. Upon receiving a raw answer, the causal analysis manager 216 again communicates with the large generative model 230 (e.g., using the plain language prompt) to generate a plain language response or answer, which is then provided to the client device 260 in response to the causal query.

As shown, the computing environment 200 includes the large generative model 230. The large generative model 230 communicates with the causal query system 206 to generate various outputs according to the framework of the causal query system 206. In some implementations, the large generative model 230 is located within the cloud computing system 202. In some implementations, the large generative model 230 represents multiple instances of the same or different large generative models. In some implementations, the large generative model 230 is a large language model (LLM).

The data resources 240 include a repository of resources available to the data operations system 204. Available resources may differ across different domains. Furthermore, data resources may vary in type. For example, some data resources are databases or data stores that record data values for various categories while other data resources are simulator models that generate data values (e.g., surrogate data values). Data resources 240 are discussed further below.

The causal analysis models 250 refer to computational models designed to analyze scripts or code to answer causal queries or make causal predictions, as described above. For example, one of the causal analysis models includes a model implemented in Python or another object-oriented programming language. In some implementations, a causal analysis model is a predictive or another type of machine-learning model.

As shown, the computing environment 200 includes the client device 260. In various implementations, the client device 260 is associated with a user (e.g., a user client device), such as a user who requests a causal query. In various instances, the client device 260 includes a client application 262, such as a web browser, mobile application, or another form of computer application for accessing and/or interacting with the cloud computing system 202 and/or the causal query system 206. For example, the client device 260 provides a causal query and/or local data to the causal query system 206. In response, the causal query system 206 generates and provides a query answer in a plain language response by following the framework described in this document.

Turning to the next figures, FIGS. 3A-3B illustrate example figures of generating a causal graph using a large generative model based on knowledgebase documents according to some implementations. In particular, FIG. 3A illustrates a block diagram showing components that the causal query system 206 communicates with to generate a causal graph, and FIG. 3B illustrates a sequence diagram for generating a causal graph.

As shown, FIG. 3A includes components such as the causal query system 206, knowledgebase documents 310, and the large generative model 230. In many implementations, the causal query system 206 uses the large generative model 230 to generate a causal graph 320 for a target domain. More particularly, the knowledgebase documents 310 and the causal graph 320 in FIG. 3A correspond to a target domain (e.g., a single domain). However, in some implementations, the knowledgebase documents 310 and the causal graph 320 correspond to multiple domains.

The knowledgebase documents 310 include publications 312, local knowledge 314, and expert input 316 for a target domain. In some implementations, the knowledgebase documents include additional or different knowledgebase documents. In general, the knowledgebase documents 310 provide a wide range of context and information for a target domain. The knowledgebase documents 310 may range from peer-reviewed expert research reports to amateur opinions.

To illustrate, the knowledgebase documents 310 show the publications 312. In various implementations, the publications 312 include scholarly and/or academic papers related to a target domain. The publications 312 may include articles, reports, papers, or other publications from the internet or other sources. Largely, the publications 312 provide authoritative knowledge on a target domain.

In various implementations, the causal query system 206 and/or another system pre-processes the publications 312. For example, the causal query system 206 indexes the publications 312 to convert the information in the publications 312 to a more digestible form. Indexing the publications 312 often improves the efficiency of the causal query system 206 being able to process and analyze them.

The local knowledge 314 provides localized knowledge on the target domain. In various implementations, the local knowledge 314 includes assessments, survey responses, amateur opinions, reviews, and user experiences for a target domain. For example, in the target domain of agricultural operations, the local knowledge 314 includes answers from a questionnaire provided by farmers.

The expert input 316 includes documents provided by experts in a target domain associated with generating a causal graph 320. For example, one or more experts provide a list (or set) of categories (or topics or entities) to include as nodes in a causal graph 320 for a target domain. In some implementations, the expert input 316 is replaced with a semi- or fully-automated process. For example, an LGM determines a list of categories to use in a target domain based on the other knowledgebase documents. In additional implementations, a user curates a list or set initially generated by an LGM.

As an example in the domain of agricultural operations, the expert input 316 may include the following categories and/or sub-categories:
Ambient Weather:
   Precipitation, air temperature, relative humidity, wind speed and direction, solar radiation
Soil Physics:
   Bulk density, soil moisture, soil temperature, soil water diffusivity
Emissions from the soil (in the atmosphere):
   Carbon dioxide, methane, nitric oxide, and nitrous oxide
Management Practices:
   Tilling, crop yield, crop type, cover crops, organic fertilizers, pesticides
Soil Structure:
   Soil texture (%_sand, %_silt, %_clay)
Soil Chemistry:
   pH, cation exchange capacity (CEC), calcium, phosphorus, sodium, magnesium, boron, manganese, iron, zinc, ammonia and ammonium, nitrogen

FIG. 3A also includes the causal query system 206 providing a prompt to the large generative model 230 to instruct the model to generate a causal graph 320 for a target domain. As shown, the resulting causal graph includes nodes 322 which represent categories of a target domain and edges 324 connecting related nodes.

With the components of FIG. 3A introduced, FIG. 3B will describe how the causal query system 206 uses these components to generate the causal graph 320. In particular, FIG. 3B illustrates a sequence diagram for generating a causal graph according to some implementations. FIG. 3B includes the knowledgebase documents 310, the causal query system 206, and the large generative model 230 introduced in FIG. 3A. FIG. 3B also includes a series of acts 300 performed by the causal query system 206.

As shown, the series of acts 300 includes act 330 of obtaining documents for a target domain. For example, the causal query system 206 receives the knowledgebase documents 310, such as the publications 312 and the local knowledge 314, from a client device and/or from various sources. In some implementations, the knowledgebase documents 310 also receive the expert input 316 that includes a list of categories, topics, or entities for a target domain. In various implementations, some or all of the knowledgebase documents 310 are provided to the causal query system 206 along with a user request to generate a causal graph for a target domain.

To elaborate, the causal query system 206 can generate a causal graph for a target domain automatically or based on a user request. In some instances, the causal query system 206 generates a causal graph in response to receiving the expert input 316 and/or a request to generate a causal graph for a target domain. In some implementations, the causal query system 206 automatically generates a causal graph for a target domain when it has access to knowledgebase documents 310.

Act 332 includes the causal query system 206 generating a causal graph creation prompt. For example, based on receiving some or all of the knowledgebase documents 310, the causal query system 206 initiates the process of creating a causal graph by generating, modifying, or otherwise obtaining an LGM prompt (e.g., a causal graph creation prompt).

In various implementations, the causal graph creation prompt instructs the large generative model 230 to analyze the knowledgebase documents 310 and determine the relationships between each of the provided categories or topics for the target domain. In some implementations, the causal query system 206 generates a separate prompt for each pair of categories being analyzed by the large generative model 230.

Act 334 includes the causal query system 206 providing the causal graph creation prompt along with the documents to the large generative model 230. For example, the causal query system 206 provides some or all of the knowledgebase documents 310 to the large generative model 230 and instructs the model to output whether a causal relationship exists between a pair of categories (or a causal correlation score between each category pair).

When a causal relationship satisfies a correlation threshold between two categories, the large generative model 230 includes an edge between the two nodes representing the categories. The resulting causal graph includes nodes 322 representing categories of a target domain and edges 324 connecting related nodes.

In some implementations, edges are a binary indication of a causal relationship. In other implementations, the edges represent a numerical measure of the causal correlation amount between two nodes. For example, if the correlation score is between 0 and 1, an edge is added to the graph when the score is above 0.4. Additionally, in some instances, an edge with a score of 0.9 is thicker than an edge with a score of 0.5. In some implementations, edges can indicate a negative correlation and may appear in a different color or pattern than edges representing positive correlations.

Act 336 illustrates the causal query system 206 receiving the causal graph 320 for the target domain from the large generative model 230. In some implementations, the large generative model 230 provides the causal graph for the target domain. In some implementations, the large generative model 230 returns values to the causal query system 206, which the causal query system 206 renders into a visual graphic of nodes and edges. The causal query system 206 may store the causal graph. Furthermore, the causal query system 206 may also store the causal graph in other forms, such as a set or table.

Turning to the next figures, FIGS. 4A-4B and FIGS. 5A-5B illustrate example figures of generating accurate and unbiased responses to causal queries. For example, FIGS. 4A-4B illustrate example diagrams generating a mapped and modified causal graph using the large generative model for a causal query according to some implementations. In particular, FIG. 4A illustrates a block diagram showing components that the causal query system 206 communicates with to generate a mapped and/or modified causal graph. FIG. 4B illustrates a sequence diagram for generating the same.

As shown, FIG. 4A includes components such as the causal query system 206 having a causal graph 406, the client device 260, the large generative model 230, and the data resources 240. The causal query system 206 uses these components to generate a mapped causal graph 408 and a modified causal graph 410 to determine causal effects associated with a causal query.

At a high level, the causal query system 206 receives a causal query from the client device 260. The causal query system 206 also obtains a dataset for the target domain. Based on identifying the target domain, the causal query system 206 obtains the causal graph 406 for the target domain (or a similar/related target domain). The causal query system 206 provides a prompt to the large generative model 230 to generate the mapped causal graph 408 based on the dataset and the causal graph 406.

If the mapped causal graph 408 is missing values, the causal query system 206 may use the large generative model 230 and the data resources 240 to obtain the missing values. The causal query system 206 may supplement the mapped causal graph 408 with the missing values to generate the modified causal graph 410.

FIG. 4B provides a more in-depth description of generating the mapped causal graph and the modified causal graph. In particular, FIG. 4B illustrates a sequence diagram of communications and actions between the causal query system 206, the large generative model 230, the data resources 240, and the client device 260. FIG. 4B also includes a series of acts 400 performed by or with the causal query system 206.

The series of acts 400 includes act 430 of the causal query system 206 receiving a causal query for a target domain from the causal query system 206. For example, a user on the client device 260 requests a causal query for a target domain. In response, the client device 260 provides the causal query directly or indirectly to the causal query system 206. For instance, the causal query system 206 provides a client application that enables a user to interact with the causal query system 206 to request a causal query. As mentioned above, in various implementations, the user request includes a normal non-causal query for the target domain.

As a non-limiting example, suppose the user is a farmer who wants to know how changing an operation will affect farming outcomes (e.g., a causal query). For instance, the farmer wants to know how adding more fertilizer, planting more seeds, using a new tractor, or changes in weather patterns (e.g., a cause) will change crop yield (e.g., an effect). Based on a cause, the farmer desires to know the effect it will have in one or more categories. In other examples, the causal query may relate to production on a factory floor, business efficiencies, or other domains.

Act 432 includes the causal query system 206 receiving a dataset for the target domain from the causal query system 206. In some instances, the client device 260 provides a dataset with data values for various categories in the target domain along with the causal query. In some implementations, the client device 260 has data values from a previously provided dataset. In various implementations, the causal query system 206 obtains data values from other sources if available (e.g., data values are available from a repository).

In one or more implementations, the dataset includes subsets of data and data values. In various implementations, the data values between categories are not uniform. For example, one category tracks data values by date and time while another category tracks by temperature or distance. As another example, one category may have many data values while another may have a few data values.

Continuing the agricultural operation example, the farmer may provide a table or spreadsheet of farm-operation-based data where each category has one or more data values. For example, the table includes data values for crop type, average annual rain, required annual rain, irrigation, month crop planted, air temperature, soil temperature, soil type, pesticides, salinity, fertilizer, expected crop yield, actual crop yield, etc. The dataset may include data values for some or all categories.

Act 434 includes the causal query system 206 obtaining the causal graph for the target domain. For example, the causal query system 206 retrieves the causal graph 406 for the target domain from a data store. In some instances, the causal query system 206 generates and/or updates the causal graph 406 in connection with receiving a causal query for the target domain.

In some implementations, the causal query system 206 is unable to identify a causal graph for the training data. In some implementations, the causal query system 206 identifies a similar causal graph, such as a causal graph of a broader (e.g., patent) domain, narrower (e.g., child) domain, or adjacent domain. In some cases, the causal query system 206 reports back to the client device 260 that no causal graph for the training data can be located and allows the user to cancel their request or work with the causal query system 206 to generate a causal graph.

Act 436 shows the causal query system 206 and the large generative model 230 interacting to determine the intent of the causal query. For example, the causal query system 206 generates and provides an intent determination prompt (e.g., an LGM prompt) to the large generative model 230 to obtain one or more intents from the causal query. In various implementations, the causal query system 206 provides the causal graph 406 and/or the dataset to the large generative model 230 along with the intent determination prompt. The large generative model 230 may return one or more intents, related causal queries, and/or suggestions for obtaining additional information from the client device 260.

Along these lines, the causal query system 206 may seek additional information from the client device 260. For example, in the farmer example, the causal query system 206 may request location information (e.g., latitude, longitude). In a factory example, the causal query system 206 may request information about the products being made or the available budgets. In general, the causal query system 206 may request information related to the dataset and/or the target domain, but that is separate from the categories included in the dataset.

Act 438 includes the causal query system 206 generating a causal query prompt based on the causal query. For example, the causal query system 206 generates one or more LGM prompts that instruct the large generative model 230 to generate a mapped causal graph by encoding data values in the dataset with corresponding nodes in the causal graph 406. In some implementations, the causal query provides detailed instructions on how the dataset and causal graph should be combined. For example, the causal query prompt instructs the large generative model 230 to perform various operations if possible and, if not, to call on a model that can perform the operations. In some implementations, the causal query prompt allows the large generative model 230 to determine how to map, encode, supplement, combine, and/or merge the dataset and causal graph for the target domain to generate the mapped causal graph 408.

In various implementations, the causal query prompt (or a separate missing data prompt) instructs the large generative model 230 to determine if nodes within the mapped causal graph 408 are missing data values. In some implementations, a node is considered to be missing data values if it includes fewer than a number or amount of data values (e.g., a minimum threshold). In various implementations, the minimum threshold varies per node or category.

Additionally, the causal query prompt (or the separate missing data prompt) provides instructions for obtaining the missing data. For example, the causal query prompt includes a list of the data resources 240 that are available to provide the missing data. In some instances, the causal query prompt lists a data store that maintains a record of data values for a given category (e.g., weather or precipitation at a particular location). In various implementations, the causal query prompt lists a simulator model (e.g., a machine-learning model) that can be used to generate or predict missing data values.

Act 440 shows the causal query system 206 generating a system prompt. As mentioned above, a system prompt provides context for the causal query prompt. In various implementations, the system prompt is tailored to the target domain. In some implementations, the instructions in the system prompt are incorporated into the causal query prompt. In one or more implementations, a system prompt (or another prompt) includes instructions and or examples that guide the large generative model to follow one or more actions being requested by the causal query system 206.

Act 442 shows the causal query system 206 providing the prompts (e.g., the causal query prompt, the missing data prompt, and/or the system prompt) to the large generative model 230 along with the dataset, and the causal graph for the large generative model 230 to generate a mapped causal graph. In various implementations, the causal query system 206 also provides the causal query within or separate from the prompt. In some instances, rather than directly providing the dataset and/or causal graph, the causal query system 206 provides the large generative model 230 with access to these resources.

Act 444 includes the large generative model 230 generating the mapped causal graph and missing value insights. For example, the large generative model 230 follows the instructions in the prompts to generate the mapped causal graph 408. In some implementations, the causal query prompt includes an output format for the mapped causal graph 408. The large generative model 230 then provides the mapped causal graph 408 to the causal query system 206.

In addition, the large generative model 230 generates missing value insights. For example, upon identifying a node with missing values, the large generative model 230 determines how to optimally fill in the missing values and complete the mapped causal graph. In some implementations, the large generative model 230 uses the list of the data resources 240 to determine one or more of the data resources 240 to access to obtain the missing value.

In some cases, the large generative model 230 provides instructions back to the causal query system 206 to select and/or obtain the missing data from the selected data resource. This is shown in act 446 as the causal query system 206 uses the missing value insights to select a data resource. Act 448 includes the causal query system 206 obtaining the missing values from the selected data resource (as part of the data resources 240). In some cases, the large generative model 230 directly calls and obtains missing data values from a selected data resource. In some instances, the causal query system 206 dynamically interacts with the client device 260 to obtain missing information, which may be added to the causal graph.

In various implementations, the large generative model 230 selects a particular simulator model to obtain the missing values for a given node. Based on the selected simulator model, the large generative model 230 determines how to call the selected simulator model and what information to provide to the selected simulator model (e.g., whether it needs data values from surrounding categories/nodes in the mapped causal graph). The large generative model 230 then obtains the missing data from the selected simulator model.

Continuing the agricultural operation example from above, suppose the large generative model 230 determines that the data values for soil moisture and pH levels are missing from the mapped causal graph. Accordingly, the large generative model 230 determines to call a first simulator model to obtain the soil moisture and a second simulator model to obtain the pH levels. In addition to providing a prompt or request, the large generative model 230 provides a location and any other data it determines is needed by the simulator models. In some instances, the same simulator model may provide both types of data (e.g., a soil data application programming interface (API)). In response, the simulator models use machine learning, heuristic modeling, or another process to determine and return the requested missing data values.

Upon receiving the missing values, the causal query system 206 may add or supplement the mapped causal graph 408 with them to generate a modified causal graph 410, as shown in act 450. In some implementations, the causal query system 206 provides the missing values to the large generative model 230 with a prompt to generate the modified causal graph 410 using them and the mapped causal graph 408. In some implementations, the large generative model 230 automatically generates the modified causal graph 410 and returns it to the causal query system 206 in response to receiving the causal query prompt, described above.

Upon generating the mapped causal graph and/or the modified causal graph, the causal query system 206 can use this holistic causal information to determine an effect of the causal query. To illustrate, FIGS. 5A-5B show example diagrams for generating a response to the causal query based on the modified causal graph and using the large generative model.

In particular, FIG. 5A illustrates a block diagram showing the components that the causal query system 206 communicates with to generate a plain language response to the causal query. FIG. 5B illustrates a sequence diagram for generating the same.

As shown, FIG. 5A includes components such as the causal query system 206 with the modified causal graph 410 (and/or the mapped causal graph 408), the client device 260, the large generative model 230, and the causal analysis models 250. The causal query system 206 uses these components to generate a plain language response to the causal query.

At a high level, the causal query system 206 provides the modified causal graph 410 to the large generative model 230 and a prompt for determining the effect of the causal query using a causal analysis model. The large generative model 230 provides a response that indicates a causal analysis model and includes instructions, guidelines, and/or a script (e.g., code) for using the causal analysis model. The causal query system 206 again prompts the large generative model 230 to generate a plain language response from the raw answer provided by the causal analysis model. Finally, the causal query system 206 provides the plain language response to the client device 260.

FIG. 5B provides a more in-depth description of determining an answer and providing a plain language response to the causal query. In particular, FIG. 5B illustrates a sequence diagram of communications and actions between the causal query system 206, the large generative model 230, the causal analysis models 250, and the client device 260. FIG. 5B also includes a series of acts 500 performed by or with the causal query system 206.

The series of acts 500 includes act 530 of the causal query system 206 generating a causal script prompt based on the causal query. In one or more implementations, the causal query system 206 generates a prompt that instructs the large generative model 230 to select a causal analysis model for determining an outcome to the causal question, if needed, and to generate code to provide to the selected causal analysis model to answer the causal question.

To illustrate, in some implementations, the causal query system 206 has access to multiple causal analysis models. In these implementations, the causal query system 206 may generate a causal script prompt (or a system prompt) that lists the models along with their capabilities. The causal query system 206 instructs the large generative model 230 to determine which of the causal analysis models is best suited to determine an outcome or answer for the causal question in the causal query. In some instances, selecting a causal analysis model may be based on a separate prompt and response from the large generative model 230. In other implementations, when only one causal analysis model is available, the causal query system 206 may select the default causal analysis model or skip selecting a model.

With a causal analysis model selected, the causal query system 206 instructs the large generative model 230 in the causal script prompt to generate code for determining the effect of the causal question (e.g., determine the causal outcome based on the treatment included in the causal query). For example, the causal script prompt includes instructions to perform a causal analysis and/or prediction using the mapped causal graph or modified causal graph.

As an example, for a causal analysis model that implements an object-oriented programming approach, the causal script prompt may include instructions to perform the causal analysis using one or more libraries and/or functions, create a model object from the provided data, identify a treatment and outcome variables, and estimate the causal effect using one or more approaches and/or counterfactual reasoning. In addition, the causal script prompt may include an example code for the large generative model 230 to follow in generating the script to provide to the causal analysis model.

Continuing the agricultural operation example, the causal script prompt may include the following:
Action:
With the data and the causal graph, we can perform causal analysis in Python using the dowhy library by following these steps:
   1. Import the necessary libraries: dowhy, numpy, and matplotlib.pyplot.
   2. Create a causal model object using the provided dataframe and the given causal graph in the Problem statement.
   3. Identify the treatment and outcome variables (Fertilizer and Crop Yield).
   4. Estimate the causal effect of the treatment (Fertilizer) on the outcome (Crop Yield) using different methods (e.g., propensity score matching, inverse probability weighting, etc.).
Overall, you can use this code as a starting point to perform the causal analysis:
Action Input:
“‘python
#Import libraries
   import dowhy
   import numpy as np
   import matplotlib.pyplot as plt
#Create a causal model object using the dataframe and causal graph
   causal_graph=“‘<the causal graph provided in the problem statement>’”
   model=dowhy.CausalModel(data=df,graph=causal_graph, treatment=‘Fertilizer’,
   outcome=‘Crop Yield’)
#Choose a method for identifying the causal estimand (e.g., backdoor)
   identified_estimand=model.identify_effect(proceed_when_unidentifiable=True)
#Estimate the causal effect of the treatment on the outcome using different methods
   methods=[‘backdoor.propensity_score_matching’,
   ‘backdoor.propensity_score_weighting’, ‘backdoor.instrumental_variables’]
results={ }
for method in methods:
   estimate=model.estimate_effect(identified_estimand, method_name=method)
   results[method]=estimate.value

Act 532 includes the causal query system 206 providing the causal script prompt to the large generative model 230 and receiving back the script. As mentioned, act 532 may be separated into multiple acts. Alternatively, act 534 may be combined with previous actions, such as combining the causal script prompt with the causal query prompt, which is discussed above.

Act 534 includes the causal query system 206 providing the causal script and the modified causal graph (or mapped causal graph) to the causal analysis models 250. In particular, the causal query system 206 provides the code including the treatment and the outcome variables generated by the large generative model 230 to the selected or default causal analysis model. In response, the causal analysis model analyzes the modified causal graph and applies the instructions in the script or code to determine an answer to the causal question (referred to as a raw causal answer or raw answer).

As shown in act 536, the causal analysis model of the causal analysis models 250 generates and returns a raw answer. In various implementations, the raw answer is a value without additional context. In the context of the agricultural operation example, the raw answer is “25.” In some implementations, the raw answer causal script prompt may include multiple values if the causal question requires multiple answers and/or if the causal script causes the causal analysis model to return answers to multiple causal questions.

Act 538 includes the causal query system 206 generating a plain language answer prompt. For example, upon receiving the raw answer from the causal analysis model, the causal query system 206 generates a plain language prompt to provide to the large generative model 230 to cause the model to generate a text narrative response in plain language to the causal query using the raw answer. In various instances, the plain language prompt also includes instructions to provide additional context information regarding the raw answer so that a layperson understands the causal answer and why it has the determined effect.

Act 540 includes the causal query system 206 providing the plain language prompt to the large generative model 230. In addition, the causal query system 206 provides the causal query. In some implementations, the causal query system 206 also provides the causal graph, dataset, mapped causal graph, and/or modified causal graph to the large generative model 230 to enable the model to better convert the raw answer into a refined plain language response.

Act 542 includes the causal query system 206 receiving a refined answer as a plain language response from the large generative model 230. For example, the causal query system 206 receives text, images, and/or links from the large generative model 230 as part of the refined answer to the causal query. In addition, the causal query system 206 provides the plain language response to the client device 260 in response to receiving the causal query, as shown in act 544.

As noted above, in the agricultural operation example, the raw answer was “25.” Based on the plain language prompt, the causal query system 206 may provide the client device 260 with a refined answer of:
Based on the question of quantifying how much adding fertilizer will affect your crop yield, treating your crops with fertilizer will result in an estimated average increase of 25 units.
In particular, based on the dataset you provided and supplemental simulated data, we determined an ATE of 25 on crop yield using a propensity score matching method. ATE refers to the difference between the average outcome of the treatment group (crops that received fertilizer) and the average outcome of the control group (crops that did not receive fertilizer).
In this case, an ATE of 25 means that the average crop yield for the treatment group is 25 units higher than the average crop yield for the control group. This suggests that the fertilizer treatment is effective in improving crop yield by an average of 25 units. However, it is important to note that this conclusion is based on statistical analysis and may not necessarily apply to every individual case.

In some implementations, before providing the refined answer to the client device 260, the causal query system 206 validates the answer. For example, the causal query system 206 generates another LGM prompt that asks whether the refined answer makes sense in the context of the causal query. If the large generative model 230 says no, the causal query system 206 can backtrack, modify one or more of the previous prompts, and try again.

FIG. 6 illustrates an example graphical user interface for interacting with the causal query system to generate a plain language answer to a causal query, according to some implementations. As illustrated, FIG. 6 includes a computing device 600 with a display showing a graphical user interface 602. The computing device 600 may be a desktop, laptop, mobile device, or another type of client device.

As shown, the graphical user interface 602 is displayed as part of a client application that allows access to functions of the causal query system 206, such as via a data operations system. For example, the client application is a web browser client application that enables a user to submit causal queries to the causal query system 206. In some implementations, the client application is a standalone application (e.g., a mobile app).

The graphical user interface 602 shows a general search display where a user can provide input for various queries included in the causal query. As shown, the graphical user interface 602 includes an input field 608 for providing a causal query. The graphical user interface 602 may include additional elements for uploading or otherwise providing datasets to the causal query system 206.

The graphical user interface 602 also includes a session record of previously asked and answered queries. To illustrate, the session record shows a causal query and response that aligns with the agricultural operation example provided above. In particular, the causal query 604 includes a causal question about crop yield based on a fertilizer treatment as well as the location of the agricultural operations. The causal query system 206 then provides the plain language response 606 to the computing device 600.

The graphical user interface 602 allows the user to ask follow-up and/or additional questions to the causal query system 206, including further causal queries using the input field 608. In various implementations, the causal query system 206 retains the mapped and/or modified causal graph and uses it for additional causal queries. This way, the causal query system 206 can bypass calling the data resources and jump straight to generating the causal script prompt (e.g., the process skips the series of acts 400 in FIG. 4B and starts with the series of acts 500 in FIG. 5B), which further improves efficiency by reducing the number of calls to the large generative model and operations to determine a causal answer while still determining an accurate and unbiased answer.

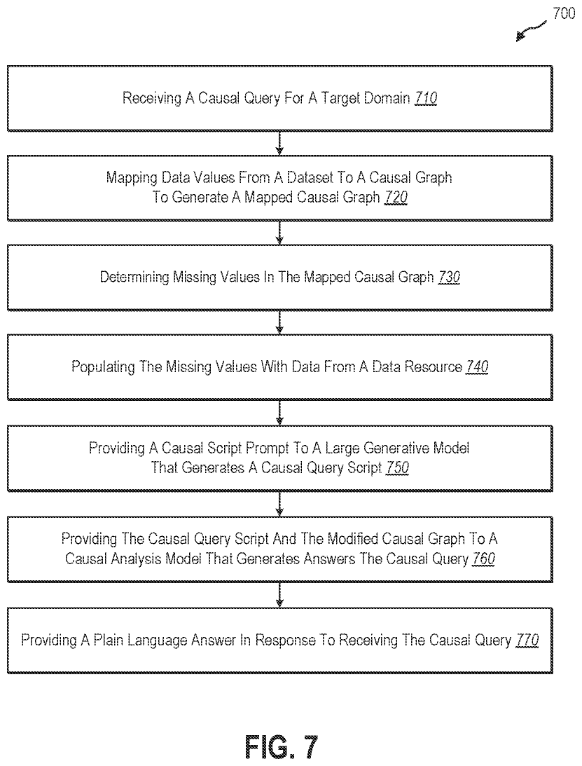

Turning now to FIG. 7, this figure illustrates an example series of acts of a computer-implemented method for generating a causal query output using a domain-based causal graph and one or more large generative models according to some implementations. While FIG. 7 illustrates acts according to one or more implementations, alternative implementations may omit, add to, reorder, and/or modify any of the acts shown.

The acts in FIG. 7 can be performed as part of a method (e.g., a computer-implemented method). Alternatively, a computer-readable medium can include instructions that, when executed by a processing system having a processor, cause a computing device to perform the acts in FIG. 7. In some implementations, a system (e.g., a processing system comprising a processor) can perform the acts in FIG. 7. For example, the system includes a processing system and a computer memory including instructions that, when executed by the processing system, cause the system to perform various actions or steps.

As shown, the series of acts 700 includes act 710 of receiving a causal query for a target domain. For instance, in example implementations, act 710 involves receiving a dataset for a target domain and a causal query corresponding to the target domain. In some implementations, act 710 includes receiving a normal, non-causal query (e.g., a query) for the target domain. In these implementations, the acts involving a causal query may be replaced with a query (e.g., a query prompt and a query script).

In some implementations, act 710 includes generating a causal query prompt to provide the large generative model based on the causal query in response to receiving the causal query and providing the causal query prompt and a system prompt to the large generative model with the causal query prompt. In some instances, the system prompt provides a set of data resources for obtaining missing dataset values for the target domain. In various implementations, the causal query prompt includes instructions to determine the intent of the causal query, the intent of the causal query is used to determine the data resource, and/or the intent of the causal query is used to generate the causal script prompt.

In some implementations, act 710 includes receiving the dataset for the target domain and the causal query from a client device and providing the plain language response answering the causal query to the client device. In some implementations, act 710 includes receiving the dataset from the client device along with the causal query.

In various implementations, the series of acts 700 includes generating the target domain causal graph using the large generative model based on categories in the target domain with knowledgebase documents from the target domain. In some implementations, the series of acts 700 includes providing a causal graph creation prompt that causes the large generative model to generate the target domain causal graph showing relationships between the categories in the target domain based on the knowledgebase documents from the target domain. In some implementations, the knowledgebase documents include academic papers from the target domain and/or questionnaire responses corresponding to the categories in the target domain.

As further shown, the series of acts 700 includes act 720 of mapping data values from a dataset to a causal graph to generate a mapped causal graph. For instance, in example implementations, act 720 involves mapping data values from the dataset to nodes in a target domain causal graph to generate a mapped causal graph. In some implementations, in connection with act 720, mapping the data values from the dataset to the nodes in the target domain causal graph includes associating one or more data values from a dataset category with the node that corresponds to the dataset category, the target domain causal graph includes nodes corresponding to categories in the target domain, various nodes in the target domain causal graph are connected with edges to indicate a relationship between connected nodes and/or the target domain causal graph is not associated with the data values before being mapped to the dataset.

As further shown, the series of acts 700 includes act 730 of determining missing values in the mapped causal graph. For instance, in some implementations, act 730 involves determining a node with missing values in the mapped causal graph. In some implementations, in connection with act 730, determining the node with the missing values in the mapped causal graph includes identifying the node in the mapped causal graph that is associated with less than a minimum number of data values.

As shown further, the series of acts 700 includes act 740 of populating the missing values with data from a data resource. For instance, in example implementations, act 740 involves populating the missing values with data obtained from a data resource to generate a modified causal graph. In some implementations, in connection with act 740, obtaining the missing values from the data resource includes identifying the data resource from the set of data resources using the large generative model and/or requesting the missing dataset values from the data resource. In some instances, the data resource includes a database of domain-based information. In some implementations, the data resource includes a machine-learning simulator model that generates the missing values for the node. In some instances, the machine-learning simulator model generates the missing values for the node based on the data values from the mapped causal graph.

As further shown, the series of acts 700 includes act 750 of providing a causal script prompt to a large generative model that generates a causal query script. For instance, in example implementations, act 750 involves providing a causal script prompt, the causal query, and the modified causal graph to a large generative model that generates a causal query script. In some implementations, act 750 includes generating the causal script prompt that causes the large generative model to generate the causal query script that instructs the causal analysis model to return the raw answer to the causal query based on the modified causal graph. In some instances, act 750 includes providing a script prompt to a large generative model that generates a query script.

As further shown, the series of acts 700 includes act 760 of providing the causal query script and the modified causal graph to a causal analysis model that generates answers (e.g., a raw answer) to the causal query. For instance, in example implementations, act 760 involves providing the causal query script and the modified causal graph to a causal analysis model that generates a raw answer to the causal query. In some implementations, act 760 includes receiving the raw answer to the causal query. In some implementations, the causal query script includes instructions written in a computer programming language to cause the causal analysis model to execute the instructions to determine the raw answer based on the modified causal graph. In some instances, act 760 includes providing the query script and the modified causal graph to a causal analysis model that generates answers (e.g., a raw answer) to the query.

As further shown, the series of acts 700 includes act 770 of providing a plain language answer in response to receiving the causal query. For instance, in some implementations, act 770 also involves providing a plain language response based on the raw answer in response to receiving the causal query. In some implementations, in connection with act 770, providing the plain language response based on the raw answer includes generating a plain language answer prompt for the large generative model to generate a refined answer based on the causal query and the raw answer, providing the plain language answer prompt to the large generative model, and/or receiving the refined answer from the large generative model to provide to a client device that requested the causal query. In some instances, act 770 includes providing a plain language answer in response to receiving the query.

In some implementations, the series of acts includes, or alternatively includes, receiving a causal query corresponding to a target domain; mapping, in response to receiving data values from a dataset for the target domain to nodes in a target domain causal graph to generate a mapped causal graph; based on determining a node with missing values in the mapped causal graph, populating the missing values with data obtained from a data resource to generate a modified causal graph obtaining the missing values to generate the modified causal graph; providing a causal script prompt, the causal query, and the modified causal graph to a large generative model to generate a causal query script; receiving a raw answer to the causal query from a causal analysis model based on providing the causal query script to the causal analysis model; and providing a plain language response to the causal query based on using the large generative model to generate the plain language response from the raw answer.

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single- or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For clarity, the various buses are illustrated in FIG. 8 as a bus system 819.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for generating a causal query output using a domain-based causal graph and one or more large generative models, comprising:
receiving a dataset for a target domain and a causal query corresponding to the target domain;
mapping data values from the dataset to nodes in a target domain causal graph to generate a mapped causal graph;
determining a node with missing values in the mapped causal graph;
populating the missing values with data obtained from a data resource to generate a modified causal graph;
providing a causal script prompt, the causal query, and the modified causal graph to a large generative model that generates a causal query script;
providing the causal query script and the modified causal graph to a causal analysis model that generates a raw answer to the causal query; and
providing a plain language response based on the raw answer in response to receiving the causal query.

2. The computer-implemented method of claim 1, further comprising:
in response to receiving the causal query, generating a causal query prompt to provide the large generative model based on the causal query; and
providing the causal query prompt and a system prompt to the large generative model with the causal query prompt, wherein the system prompt provides a set of data resources for obtaining missing dataset values for the target domain.

3. The computer-implemented method of claim 2, wherein:
the causal query prompt includes instructions to determine an intent of the causal query;
the intent of the causal query is used to determine the data resource; and
the intent of the causal query is used to generate the causal script prompt.

4. The computer-implemented method of claim 2, wherein obtaining the missing values from the data resource comprises:
identifying the data resource from the set of data resources using the large generative model; and
requesting the missing dataset values from the data resource.

5. The computer-implemented method of claim 1, wherein the data resource comprises a database of domain-based information.

6. The computer-implemented method of claim 1, wherein the data resource comprises a machine-learning simulator model that generates the missing values for the node.

7. The computer-implemented method of claim 6, wherein the machine-learning simulator model generates the missing values for the node based on the data values from the mapped causal graph.

8. The computer-implemented method of claim 1, wherein mapping the data values from the dataset to the nodes in the target domain causal graph includes associating one or more data values from a dataset category with the node that corresponds to the dataset category.

9. The computer-implemented method of claim 1, wherein:
the target domain causal graph includes nodes corresponding to categories in the target domain;
various nodes in the target domain causal graph are connected with edges to indicate a relationship between connected nodes; and
the target domain causal graph is not associated with the data values before being mapped to the dataset.

10. The computer-implemented method of claim 1, wherein determining the node with the missing values in the mapped causal graph includes identifying the node in the mapped causal graph that is associated with less than a minimum number of data values.

11. The computer-implemented method of claim 1, further comprising:
generating the causal script prompt that causes the large generative model to generate the causal query script that instructs the causal analysis model to return the raw answer to the causal query based on the modified causal graph; and
receiving the raw answer to the causal query.

12. The computer-implemented method of claim 1, wherein providing the plain language response based on the raw answer includes:
generating a plain language answer prompt for the large generative model to generate a refined answer based on the causal query and the raw answer;
providing the plain language answer prompt to the large generative model; and
receiving the refined answer from the large generative model to provide to a client device that requested the causal query.

13. The computer-implemented method of claim 1, further comprising:
generating the target domain causal graph using the large generative model based on categories in the target domain with knowledgebase documents from the target domain.

14. The computer-implemented method of claim 13, further comprising:
providing a causal graph creation prompt that causes the large generative model to generate the target domain causal graph showing relationships between the categories in the target domain based on the knowledgebase documents from the target domain.

15. The computer-implemented method of claim 13, wherein the knowledgebase documents include academic papers from the target domain and questionnaire responses corresponding to the categories in the target domain.

16. The computer-implemented method of claim 1, wherein the causal query script includes instructions written in a computer programming language to cause the causal analysis model to execute the instructions to determine the raw answer based on the modified causal graph.

17. A computer-implemented method comprising:
receiving a query corresponding to a target domain;
mapping, in response to receiving data values from a dataset for the target domain to nodes in a target domain causal graph to generate a mapped causal graph;
based on determining a node with missing values in the mapped causal graph, populating the missing values with data obtained from a data resource to generate a modified causal graph obtaining the missing values to generate the modified causal graph;
providing a causal script prompt, the query, and the modified causal graph to a large generative model to generate a query script;
receiving a raw answer to the query from a causal analysis model based on providing the query script to the causal analysis model; and
providing a plain language response to the query based on using the large generative model to generate the plain language response from the raw answer.

18. The computer-implemented method of claim 17, further comprising:
receiving the dataset for the target domain and the query from a client device; and
providing the plain language response answering the query to the client device.

19. The computer-implemented method of claim 18, further comprising receiving the dataset from the client device along with the query.

20. A system for generating a causal query output using a domain-based knowledge graph and one or more large generative models, comprising:
a processing system; and
a computer memory comprising instructions that, when executed by the processing system, cause the system to perform operations of:
receiving a dataset for a target domain and a causal query corresponding to the target domain;
mapping data values from the dataset to nodes in a target domain causal graph to generate a mapped causal graph;
determining a node with missing values in the mapped causal graph;
populate the missing values with data obtained from a data resource to generate a modified causal graph;
providing a causal script prompt, the causal query, and the modified causal graph to a large generative model that generates a causal query script;
providing the causal query script and the modified causal graph to a causal analysis model that generates a raw answer to the causal query;
generating a plain language answer prompt for the large generative model to generate a refined answer based on the causal query and the raw answer; and
providing a plain language response in response to the causal query.
